(19) United States
(12) Patent Application Publication
(10) Pub. No.: US 2026/0300274 A1
(43) Pub. Date: Oct. 1, 2026

(54) DATABASE QUERYING USING NATURAL LANGUAGE PROCESSING

(71) Applicant: International Business Machines Corporation, Armonk, NY (US)

(72) Inventors: Timothy Rea DINGER, Croton-on-Hudson, NY (US); Alfio Massimiliano GLIOZZO, Brooklyn, NY (US); Nhan Huu PHAM, Tarrytown, NY (US); Oktie HASSANZADEH, Briarcliff Manor, NY (US); Dharmashankar SUBRAMANIAN, Rye Brook, NY (US); Lisa AMINI, Weston, MA (US); Gaetano ROSSIELLO, Brooklyn, NY (US); Md Faisal Mahbub CHOWDHURY, Ardsley, NY (US); Long VU, Chappaqua, NY (US); Tanvi KAPLE, Atlanta, GA (US); Michael Robert GLASS, Bayonne, NJ (US)

(21) Appl. No.: 19/091,100

(22) Filed: Mar. 26, 2025

(51) Int. Cl. G06F 16/242; G06F 16/2452

(52) U.S. Cl. CPC G06F 16/243; G06F 16/24522

(57) ABSTRACT

In some implementations, a method includes receiving a database schema identifying a set of characteristics of a target database. The method includes determining or generating a group of database concept sets for the target database, wherein each database concept set includes a primary concept and a set of secondary concepts. The method includes generating a group of first query parts relating to the group of database concept sets. The method includes generating a group of second query parts corresponding to the group of first query parts, wherein the group of first query parts includes one or more natural language query parts and wherein the group of second query parts includes one or more corresponding query language query parts.

The method includes outputting a dataset identifying the group of first query parts and the group of second query parts corresponding to the group of first query parts.

### BACKGROUND

This disclosure relates to computing systems, and more specifically, to querying a database using natural language processing.

### SUMMARY

In some implementations, a computer-implemented method includes receiving, by a processor set, a database schema identifying a set of characteristics of a target database. The method includes determining, by the processor set and based on the database schema, a group of database concept sets for the target database, wherein each database concept set, of the group of database concept sets, includes a primary concept and a set of secondary concepts relating to the primary concept. The method includes generating, by the processor set, a group of first query parts relating to the group of database concept sets. The method includes generating, by the processor set, a group of second query parts corresponding to the group of first query parts, wherein the group of first query parts includes one or more natural language query parts and wherein the group of second query parts includes one or more corresponding query language query parts. The method includes outputting, by the processor set, a dataset identifying the group of first query parts and the group of second query parts corresponding to the group of first query parts.

In some implementations, a computer system includes a processor set; one or more computer-readable storage media; and program instructions stored on the one or more computer-readable storage media to cause the processor set to perform operations including receiving information identifying a database. The computer system is caused to perform operations including determining a database schema for the database. The computer system is caused to perform operations including generating a set of high-level concepts related to a database schema. The computer system is caused to perform operations including generating a set of natural language questions based on the high-level concepts. The computer system is caused to perform operations including generating a set of structured query language (SQL) queries corresponding to the natural language questions. The computer system is caused to perform operations including filtering the set of SQL queries based on a set of execution results to generate a set of filtered SQL queries. The computer system is caused to perform operations including revising, based on filtering the set of SQL queries, the set of natural language questions to generate a set of revised natural language queries. The computer system is caused to perform operations including filtering the set of revised natural language questions and the set of filtered SQL queries based on schema linking to generate a final dataset of paired natural language questions and SQL queries. The computer system is caused to perform operations including outputting the final dataset of paired natural language questions and SQL queries.

In some implementations, a computer program product includes a processor set; one or more computer-readable storage media; and program instructions stored on the one or more computer-readable storage media to cause the processor set to perform operations including receiving a database schema identifying a set of characteristics of a target database. The processor set is caused to perform operations including determining, based on the database schema, a group of database concepts for the target database. The processor set is caused to perform operations including generating a set of natural language statements relating to the group of database concept sets. The processor set is caused to perform operations including generating a set of structured language statements corresponding to the set of natural language statements. The processor set is caused to perform operations including executing the set of structured language statements. The processor set is caused to perform operations including filtering the set of structured language statements based on a set of results of executing the set of structured language statements. The processor set is caused to perform operations including updating the set of natural language statements based on filtering the set of structured language statements. The processor set is caused to perform operations including outputting a dataset identifying a result of updating the set of natural language statements and filtering the set of structured language statements.

### BRIEF DESCRIPTION OF THE DRAWINGS

FIG. 1 is a diagram of an example computing environment for database querying using natural language processing described herein.

FIGS. 2A-2D are diagrams of an example implementation associated with database querying using natural language processing.

FIG. 3 is a diagram of example components of a device associated with database querying using natural language processing.

FIG. 4 is a flowchart of an example process associated with database querying using natural language processing.

### DETAILED DESCRIPTION

The following detailed description of example implementations refers to the accompanying drawings. The same reference numbers in different drawings may identify the same or similar elements.

Large databases often contain complex schemas and vast amounts of data, making it challenging for users to explore and gain insights from the data. Existing methods for database exploration, such as manual querying (e.g., using structured query language (SQL)) or using pre-defined query templates, can be time-consuming and may not always yield relevant results. Furthermore, generating high-quality training data for text-to-SQL models, which can aid in database exploration, is a labor-intensive and costly process that uses potentially inaccurate human annotation. Accordingly, database exploration relies heavily on human expertise and manual effort, which can lead to inconsistent and incomplete results. For example, techniques for generating training data for text-to-SQL models may rely on human annotation, which can be time-consuming and error prone, resulting in models that provide error prone results. Moreover, the quality of the generated questions and SQL queries is significant in determining the accuracy of the insights gained from the database.

Some implementations described herein provide a system for automatically generating focused questions and SQL query pairs to aid in database exploration and data recall. For example, the system may receive a database schema identifying a set of characteristics of a target database, determine a group of database concept sets for the target database based on the database schema, generate a set of natural language query parts relating to the group of database concept sets, generate a set of corresponding query language query parts (e.g., SQL query parts), and output a dataset identifying the set of query language query parts and the set of natural language query parts. In some aspects, the system may filter the query language query parts based on execution results, revise the natural language query parts based on the filtered query language query parts, and filter the revised query parts based on schema linking to generate a final dataset of paired natural language questions and query language queries.

In this way, the system may reduce the computational complexity of database exploration and data recall by automating the generation of relevant queries, thereby minimizing the number of redundant or irrelevant queries executed on the database. The system may optimize the utilization of system resources, such as processing resources, memory resources, and network resources, by streamlining the database exploration process and data recall process and by reducing the need for manual intervention. Additionally, the system may improve the efficiency of text-to-SQL models by providing high-quality training data, which can enhance the accuracy and performance of such models. In this way, the system may conserve processing resources, memory resources, network resources, and/or the like.

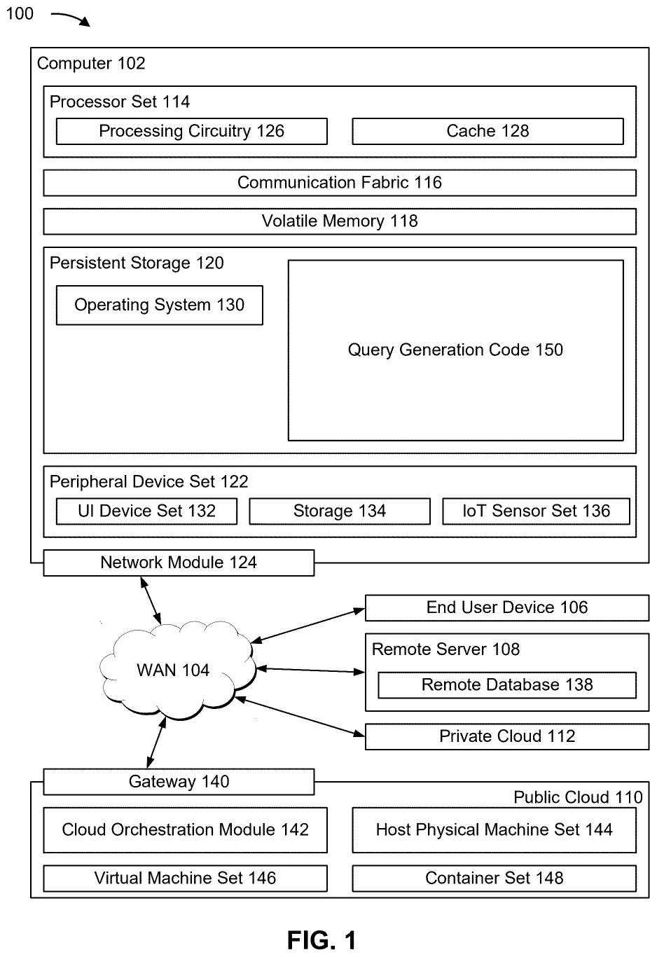

FIG. 1 is a diagram of an example computing environment 100 for database querying using natural language processing described herein.

The computing environment 100 contains an example of an environment for the execution of at least some of the computer code involved in performing the inventive methods, such as query generation code 150. In addition to the query generation code 150, the computing environment 100 includes, for example, a computer 102, a wide area network (WAN) 104, an end user device (EUD) 106, a remote server 108, a public cloud 110, and a private cloud 112. In this embodiment, the computer 102 includes a processor set 114 (including processing circuitry 126 and a cache 128), communication fabric 116, volatile memory 118, persistent storage 120 (including an operating system 130 and the query generation code 150, as identified above), a peripheral device set 122 (including a user interface (UI) device set 132, storage 134, and an Internet of Things (IOT) sensor set 136), and a network module 124. The remote server 108 includes a remote database 138. The public cloud 110 includes a gateway 140, a cloud orchestration module 142, a host physical machine set 144, a virtual machine set 146, and a container set 148.

The computer 102 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as the remote database 138. As is well understood in the art of computer technology, and depending upon the technology, performance of a computer-implemented method may be distributed among multiple computers and/or between multiple locations. On the other hand, in this presentation of the computing environment 100, detailed discussion is focused on a single computer, specifically the computer 102, to keep the presentation as simple as possible. The computer 102 may be located in a cloud, even though it is not shown in a cloud in FIG. 1. On the other hand, the computer 102 is not required to be in a cloud except to any extent as may be affirmatively indicated.

Computer-readable program instructions are typically loaded onto the computer 102 to cause a series of operational steps to be performed by the processor set 114 of the computer 102 and thereby effect a computer-implemented method, such that the instructions thus executed will instantiate the methods specified in flowcharts and/or narrative descriptions of computer-implemented methods included in this document (collectively referred to as “the inventive methods”). These computer-readable program instructions are stored in various types of computer-readable storage media, such as the cache 128 and the other storage media discussed below. The program instructions, and associated data, are accessed by the processor set 114 to control and direct performance of the inventive methods. In the computing environment 100, at least some of the instructions for performing the inventive methods may be stored in query generation code 150 in the persistent storage 120.

The communication fabric 116 is the signal conduction path that allows the various components of the computer 102 to communicate with each other. Typically, this fabric is made of switches and electrically conductive paths, such as the switches and electrically conductive paths that make up buses, bridges, and/or physical input/output ports, among other examples. Other types of signal communication paths may be used, such as fiber optic communication paths and/or wireless communication paths, among other examples.

The volatile memory 118 is any type of volatile memory now known or to be developed in the future. Examples include dynamic type random access memory (RAM) or static type RAM. Typically, the volatile memory 118 is characterized by random access, but this is not required unless affirmatively indicated. In the computer 102, the volatile memory 118 is located in a single package and is internal to the computer 102, but, alternatively or additionally, the volatile memory 118 may be distributed over multiple packages and/or located externally with respect to the computer 102.

The code included in the query generation code 150 typically includes at least some of the computer code involved in performing one or more operations described herein. The operations may include, for example, receiving a database schema identifying a set of characteristics of a target database; determining, based on the database schema, a group of database concept sets for the target database, wherein each database concept set, of the group of database concept sets, includes a primary concept and a set of secondary concepts relating to the primary concept; generating a group of first query parts relating to the group of database concept sets; generating a group of second query parts corresponding to the group of first query parts, wherein the group of first query parts includes one or more natural language query parts and wherein the group of second query parts includes one or more corresponding query language query parts; and outputting a dataset identifying the group of first query parts and the group of second query parts corresponding to the group of first query parts.

The peripheral device set 122 includes the set of peripheral devices of the computer 102. Data communication connections between the peripheral devices and the other components of the computer 102 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, the UI device set 132 may include components such as a display screen, speaker, microphone, wearable devices (such as goggles and smart watches), keyboard, mouse, printer, touchpad, game controllers, and haptic devices. The storage 134 is external storage, such as an external hard drive, or insertable storage, such as an SD card. The storage 134 may be persistent and/or volatile. In some embodiments, the storage 134 may take the form of a quantum computing storage device for storing data in the form of qubits. In embodiments where the computer 102 is required to have a large amount of storage (for example, where the computer 102 locally stores and manages a large database), then this storage may be provided by peripheral storage devices designed for storing very large amounts of data, such as a storage area network (SAN) that is shared by multiple, geographically distributed computers. The IoT sensor set 136 is made up of sensors that can be used in Internet of Things applications. For example, one sensor may be a thermometer and another sensor may be a motion detector.

The network module 124 is the collection of computer software, hardware, and firmware that allows the computer 102 to communicate with other computers through the WAN 104. The network module 124 may include hardware, such as modems or Wi-Fi signal transceivers, software for packetizing and/or de-packetizing data for communication network transmission, and/or web browser software for communicating data over the internet. In some embodiments, network control functions and network forwarding functions of the network module 124 are performed on the same physical hardware device. In other embodiments (for example, embodiments that utilize software-defined networking (SDN)), the control functions and the forwarding functions of the network module 124 are performed on physically separate devices, such that the control functions manage several different network hardware devices. Computer-readable program instructions for performing the inventive methods can typically be downloaded to the computer 102 from an external computer or external storage device through a network adapter card or network interface included in the network module 124.

The WAN 104 is any wide area network (for example, the internet) capable of communicating computer data over non-local distances by any technology for communicating computer data, now known or to be developed in the future. In some embodiments, the WAN 104 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers, and/or edge servers, among other examples.

The EUD 106 is any computer system that is used and controlled by an end user (for example, a customer of an enterprise that operates the computer 102), and may take any of the forms discussed above in connection with the computer 102. The EUD 106 typically receives helpful and useful data from the operations of the computer 102. For example, in a hypothetical case where the computer 102 is designed to provide a recommendation to an end user, this recommendation would typically be communicated from the network module 124 of the computer 102 through the WAN 104 to the EUD 106. In this way, the EUD 106 can display, or otherwise present, the recommendation to an end user. In some embodiments, the EUD 106 may be a client device, such as thin client, heavy client, mainframe computer, and/or desktop computer, among other examples.

The remote server 108 is any computer system that serves at least some data and/or functionality to the computer 102. The remote server 108 may be controlled and used by the same entity that operates the computer 102. The remote server 108 represents the machine(s) that collect and store helpful and useful data for use by other computers, such as the computer 102. For example, in a hypothetical case where the computer 102 is designed and programmed to provide a recommendation based on historical data, then this historical data may be provided to the computer 102 from the remote database 138 of the remote server 108.

The public cloud 110 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of the public cloud 110 is performed by the computer hardware and/or software of the cloud orchestration module 142. The computing resources provided by the public cloud 110 are typically implemented by virtual computing environments that run on various computers making up the computers of the host physical machine set 144, which is the universe of physical computers in and/or available to the public cloud 110. The virtual computing environments (VCEs) typically take the form of virtual machines from the virtual machine set 146 and/or containers from the container set 148. It is understood that these VCEs may be stored as images and may be transferred among and between the various physical machine hosts, either as images or after instantiation of the VCE. The cloud orchestration module 142 manages the transfer and storage of images, deploys new instantiations of VCEs and manages active instantiations of VCE deployments. The gateway 140 is the collection of computer software, hardware, and firmware that allows the public cloud 110 to communicate through the WAN 104.

Some further explanation of VCEs will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

The private cloud 112 is similar to the public cloud 110, except that the computing resources are only available for use by a single enterprise. While the private cloud 112 is depicted as being in communication with the WAN 104, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, the public cloud 110 and the private cloud 112 are both part of a larger hybrid cloud.

Cloud computing services and/or microservices (not separately shown in FIG. 1): private cloud 112 and public clouds 110 are programmed and configured to deliver cloud computing services and/or microservices (unless otherwise indicated, the word “microservices” shall be interpreted as inclusive of larger “services” regardless of size). Cloud services are infrastructure, platforms, or software that are typically hosted by third-party providers and made available to users through the internet. Cloud services facilitate the flow of user data from front-end clients (for example, user-side servers, tablets, desktops, laptops), through the internet, to the provider's systems, and back. In some embodiments, cloud services may be configured and orchestrated according to as “as a service” technology paradigm where something is being presented to an internal or external customer in the form of a cloud computing service. As-a-Service offerings typically provide endpoints with which various customers interface. These endpoints are typically based on a set of application programming interfaces (APIs). One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (SaaS) where software is centrally hosted and allocated on a subscription basis. SaaS is also known as on-demand software, web-based software, or web-hosted software. Four technological sub-fields involved in cloud services are: deployment, integration, on demand, and virtual private networks.

FIG. 1 is provided as an example. Other examples may differ from what is described with regard to FIG. 1.

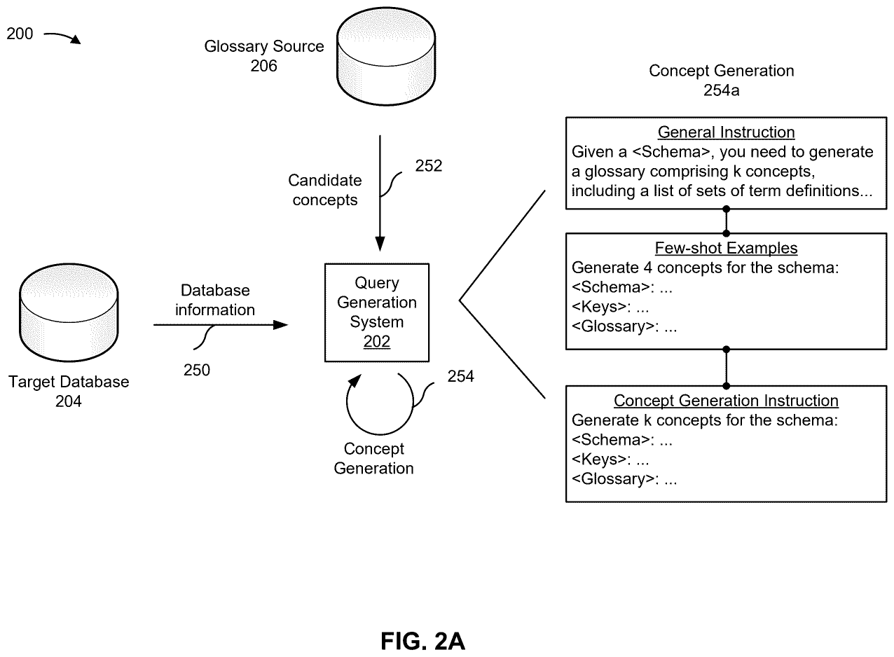

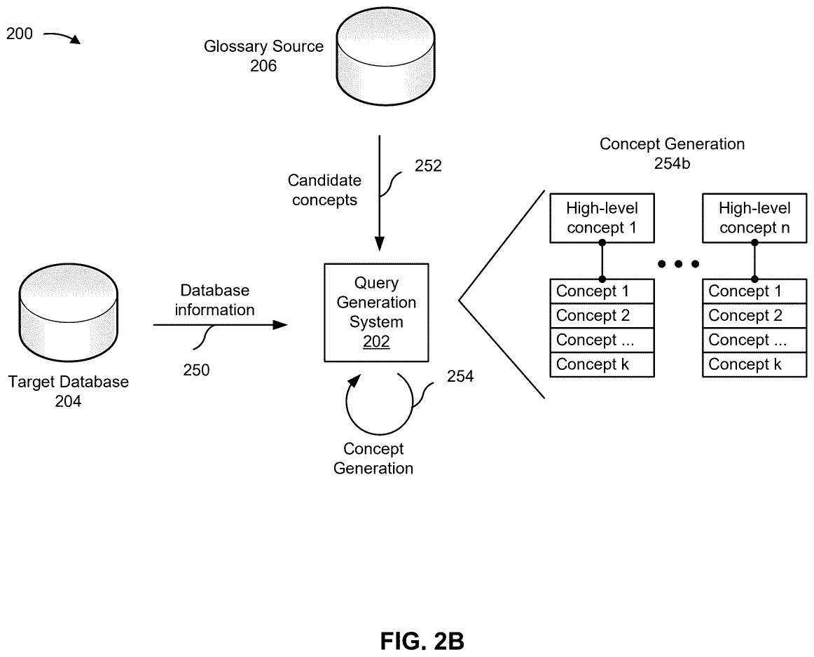

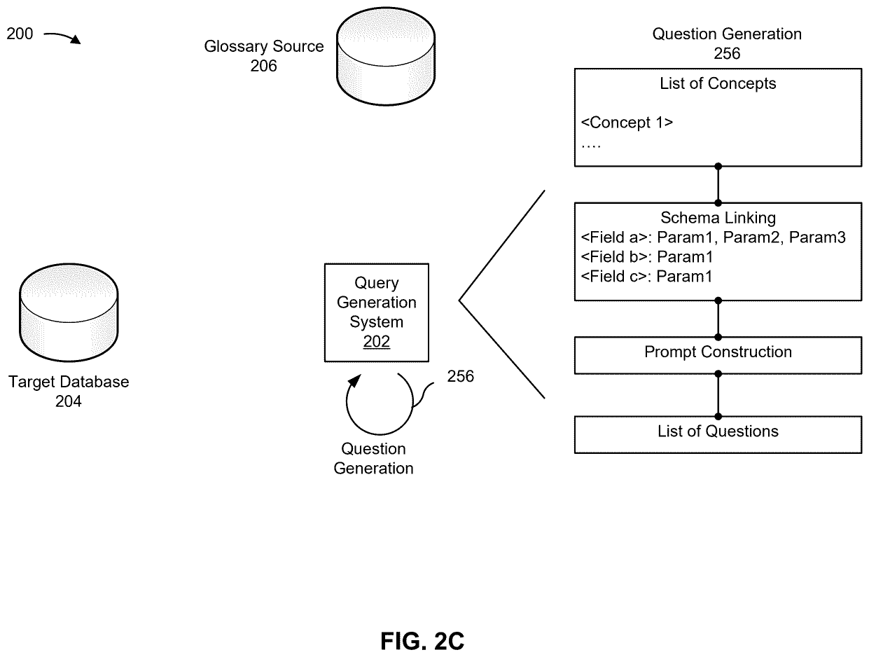

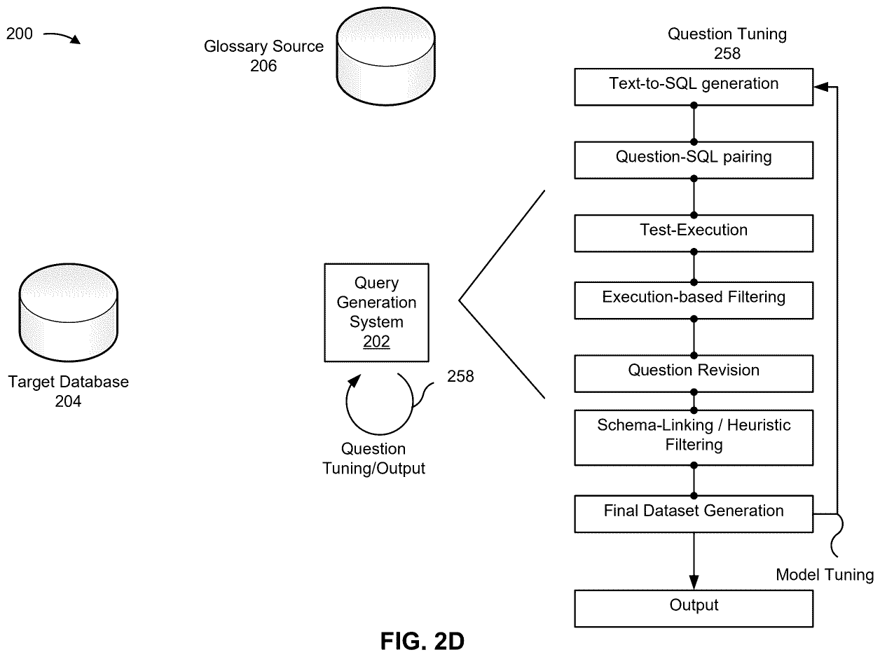

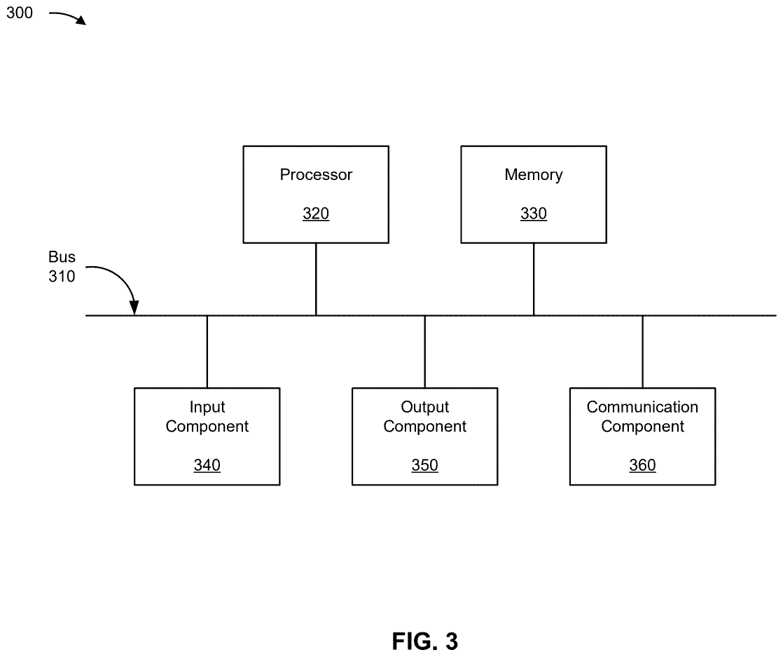

FIGS. 2A-2D are diagrams of an example implementation 200 associated with database querying using natural language processing. As shown in FIGS. 2A-2D, example implementation 200 includes a query generation system 202, a target database 204, and a glossary source 206. These devices are described in more detail below in connection with FIG. 1 and FIG. 3.

As further shown in FIG. 2A, and by reference number 250, the query generation system 202 receives database information from a target database 204. For example, the query generation system 202 may receive information identifying a database schema. The database schema may identify a set of characteristics of a target database, such as names of tables or columns or relationships between the tables or columns, among other examples. In some implementations, the target database 204 may include a relational database, and the query generation system 202 may receive the database information in the form of a schema representation. As an example, the target database 204 may include a database containing data related to customer segmentation, and the database information may include a schema with tables for customer information, purchase history, or demographic data, among other examples.

As further shown in FIG. 2A, and by reference number 252, the query generation system 202 may receive candidate concepts from a glossary source 206. The candidate concepts may include high-level topics or themes related to the domain of the target database 204. As an example, when the target database 204 includes data related to customer segmentation, the candidate concepts may include topics such as “customer demographics,” “purchase behavior,” and “market trends.” In some implementations, the glossary source 206 may include a database or a file including a set of pre-defined concepts and associated descriptions. As an example, the glossary source 206 may include a knowledge graph that provides a set of concepts and associated relationships, and the query generation system 202 may use this information to generate candidate concepts.

As further shown in FIG. 2A, and by reference number 254, the query generation system 202 may perform concept generation. As shown by reference number 254a, as part of concept generation, the query generation system 202 generates a general instruction, a set of few-shot examples, and a concept generation instruction. The general instruction may include a prompt or a question that provides context for the concept generation process. For example, the general instruction may be “generate concepts related to customer segmentation.” The few-shot examples may include a set of examples that illustrate the type of concepts that are relevant to the target database 204. The concept generation instruction may include a specific instruction that guides the generation of concepts, such as “generate concepts that are related to customer demographics and purchase behavior.” The query generation system 202 may use the general instruction, few-shot examples, and concept generation instruction, to generate a set of concepts that are relevant to the target database 204 and can be used to generate natural language questions and SQL queries.

As shown in FIG. 2B, and by reference number 254b, as part of concept generation, the query generation system 202 may generate a set of high-level concepts and associated detailed concepts. The query generation system 202 may use a nested generation technique to generate high-level concepts associated with the target database 204. For example, the query generation system 202 performs a concept generation step to generate a list of n high-level concepts from the target database schema. As an example, a target database schema for a financial database may include tables for customer information, transaction records, and account balances. The concept generation step may include the query generation system 202 generating a list of high-level concepts such as “Customer Segmentation,” “Financial Analysis,” and “Risk Assessment.”

As described above, the concept generation step uses in-context learning with a few-shot example prompt structure to generate an initial set of the high-level concepts. For example, the prompt structure may include the following elements: A general instruction, such as “Generate high-level concepts related to a financial database”; a few-shot example, such as “Customer Segmentation” or “Financial Analysis”; and a database schema representation, such as a list of tables and columns in the financial database. The query generation system 202 may use a language model with the aforementioned elements to generate a list of high-level concepts that are relevant to the target database. For example, as an output, the query generation system 202 may generate: “High-level concept 1: ‘Customer Segmentation’”; “High-level concept 2: ‘Financial Analysis’”; and “High-level concept 3: ‘Risk Assessment’”. For each generated high-level concept, the query generation system 202 may repeat the concept generation step to generate a list of k fine-level concepts that are associated with the high-level concepts. For example, for the high-level concept “Customer Segmentation”, the query generation system 202 may generate a list of fine-level concepts such as: “Fine-level concept 1: ‘Demographic Analysis’”; “Fine-level concept 2: ‘Behavioral Analysis’”; and “Fine-level concept 3: ‘Purchase History Analysis’”. The query generation system 202 may generate the fine-level concepts using the same prompt structure as the high-level concepts, with the addition of the high-level concept as an input. For example, a prompt structure, used by the query generation system 202, for generating fine-level concepts for the high-level concept ‘Customer Segmentation’ may include a general instruction (e.g., “Generate fine-level concepts related to Customer Segmentation”), a few-shot example (e.g., “Demographic Analysis” or “Behavioral Analysis”), or a database schema representation (e.g., a list of tables and columns in the financial database that are relevant to customer segmentation). For a set of fine-level concepts, the query generation system 202 may add the high-level concept “Customer Segmentation” as input. In some implementations, query generation system 202 may perform post-processing to remove duplicates and obtain a final set of concepts associated with the target database schema.

As shown in FIG. 2C, and by reference number 256, the query generation system 202 may perform a question generation procedure. For example, the query generation system 202 uses a concept-driven question generation approach to generate natural language questions associated with the target database 204. In some implementations, the query generation system 202 iterates through a set of concepts and generates a list of questions for each concept In some implementations, to generate a set of questions, the query generation system 202 may provide a general instruction to instruct a large language model to generate questions for each concept. In some implementations, the query generation system 202 may provide few-shot examples to illustrate how relevant questions are generated using an example database and may include a question generation instruction to provide schema representation regarding a concept for which to generate questions.

In some implementations, the query generation system 202 performs a schema linking procedure to identify relevant fields and parameters of a target database 204. For example, the query generation system 202 may identify one or more relevant tables and columns in the target database schema that are associated with each selected concept in the concept list. As an example, for the concept “Customer Segmentation,” the schema linking step may identify the tables “Customer” and “Transaction” and the columns “Customer ID”, “Age”, and “Income” as relevant. In some implementations, the query generation system 202 may use a thresholding technique to filter selected concepts in connection with schema linking. For example, the query generation system 202 may generate relevance scores and may filter out columns with low relevance scores, thereby ensuring that only relevant columns are used for schema linking.

Based on schema linking, the query generation system 202 may perform a prompt construction procedure to generate a prompt for generating natural language questions. The prompt may include a general instruction, such as “Generate natural language questions related to Customer Segmentation”, a few-shot example, such as “What is the average age of customers who have made a purchase in the last 6 months?”, a database schema representation, such as a list of tables and columns in the financial database that are relevant to customer segmentation, and/or an identification of the selected concept “Customer Segmentation”. In this case, the query generation system 202 uses a language model with the aforementioned prompt elements to generate a list of natural language questions that are relevant to the concept “Customer Segmentation”. In such an example, the query generation system 202 may generate an output of: “Question 1: ‘What is the average income of customers who have made a purchase in the last 6 months?’”; “Question 2: ‘What is the distribution of customer ages who have made a purchase in the last 6 months?’”; or “Question 3: ‘What is the average purchase amount of customers who have made a purchase in the last 6 months?’”; among other examples. The query generation system 202 may repeat the question generation step for each selected concept, thereby generating a list of natural language questions for each concept.

As shown in FIG. 2D, and by reference number 258, the query generation system 202 may perform a question tuning procedure and may output a final dataset. For example, the query generation system 202 may use a text-to-query-language (e.g., a text-to-SQL) generation procedure to generate query language queries (e.g., SQL queries) for each natural language question in a set of natural language questions. As an example, for a natural language question “What is the average income of customers who have made a purchase in the last 6 months?”, the query generation system 202 may use a text-to-SQL model to generate a SQL query “SELECT AVG(income) FROM customers WHERE purchase_date>NOW()−INTERVAL 6 MONTH”.

In some implementations, the query generation system 202 performs a natural-language-question-to-query-language-question pairing step to pair each natural language question with a corresponding SQL query. For example, the query generation system 202 may pair the natural language question “What is the average income of customers who have made a purchase in the last 6 months?” with the SQL query “SELECT AVG(income) FROM customers WHERE purchase_date>NOW()−INTERVAL 6 MONTH” in a dataset of natural language query and query language query pairs.

In some implementations, the query generation system 202 may performs a test-execution step to test execute each query language query on the target database 204. For example, the query generation system 202 may execute SQL queries on the target database 204 and determine a set of results. As an example, the query generation system 202 executes the SQL query “SELECT AVG(income) FROM customers WHERE purchase_date>NOW()−INTERVAL 6 MONTH” on the target database 204 to retrieve the average income of customers who have made a purchase in the last 6 months. Based on the test-execution of the set of SQL queries, the query generation system 202 performs an execution-based filtering to filter out question-SQL pairs based on the results of execution. For example, the query generation system 202 may determine whether an execution criterion is satisfied, such as a result having an expected form for a particular query. For example, if the SQL query “SELECT AVG(income) FROM customers WHERE purchase_date>NOW()−INTERVAL 6 MONTH” returns an empty result set or an error, the query generation system 202 may filter out the corresponding natural language question-SQL pair from a dataset. In this case, the query generation system 202 may remove a candidate query (e.g., a natural language question-SQL pair) from the dataset based on the execution criterion not being satisfied or may include a candidate query in a final dataset based on the execution criterion being satisfied.

In some implementations, the query generation system 202 may perform a question revision procedure to revise one or more natural language questions based on the results of test-execution and filtering. For example, if the SQL query “SELECT AVG(income) FROM customers WHERE purchase_date>NOW()−INTERVAL 6 MONTH” returns a result set with a single row, the corresponding natural language question may be revised to “What is the average income of the customer who have made a purchase in the last 6 months”. In some implementations, the query generation system 202 may perform a schema-linking/heuristic filtering procedure. For example, the query generation system 202 may filter out question-SQL pairs based on the relevance of the SQL query to the natural language question. For example, if the SQL query “SELECT AVG(income) FROM customers WHERE purchase_date>NOW()−INTERVAL 6 MONTH” returns a result that does not correspond to the natural language question “What is the average income of customers who have made a purchase in the last 9 months?”, such as a non-numerical result, the query generation system 202 may filter out the corresponding question-SQL pair from a dataset of question-SQL pairs. Based on relevance filtering, the query generation system 202 generates a final dataset of question-SQL pairs by selecting the question-SQL pairs that have passed the execution-based filtering and schema-linking/heuristic filtering steps. Based on generating the final dataset, the query generation system 202 outputs the final question-SQL pairs as a dataset that can be used to fine-tune a text-to-SQL model. In some implementations, the output may be in the form of a JavaScript Object Notation (JSON) file. Additionally, or alternatively, the query generation system 202 may output the final dataset to a client device for use in accessing the target database 204. Additionally, or alternatively, the query generation system 202 may use the final question-SQL pairs to fine-tune the text-to-SQL model. The fine-tuned model can be used to generate SQL queries for new natural language questions.

As indicated above, FIGS. 2A-2D are provided as an example. Other examples may differ from what is described with regard to FIGS. 2A-2D. The number and arrangement of devices shown in FIGS. 2A-2D are provided as an example. In practice, there may be additional devices, fewer devices, different devices, or differently arranged devices than those shown in FIGS. 2A-2D. Furthermore, two or more devices shown in FIGS. 2A-2D may be implemented within a single device, or a single device shown in FIGS. 2A-2D may be implemented as multiple, distributed devices. Additionally, or alternatively, a set of devices (e.g., one or more devices) shown in FIGS. 2A-2D may perform one or more functions described as being performed by another set of devices shown in FIGS. 2A-2D.

FIG. 3 is a diagram of example components of a device 300 associated with database querying using natural language processing. The device 300 may correspond to the query generation system 202. In some implementations, the query generation system 202 may include one or more devices 300 and/or one or more components of the device 300. As shown in FIG. 3, the device 300 may include a bus 310, a processor 320, a memory 330, an input component 340, an output component 350, and/or a communication component 360.

The bus 310 may include one or more components that enable wired and/or wireless communication among the components of the device 300. The bus 310 may couple together two or more components of FIG. 3, such as via operative coupling, communicative coupling, electronic coupling, and/or electric coupling. For example, the bus 310 may include an electrical connection (e.g., a wire, a trace, and/or a lead) and/or a wireless bus. The processor 320 may include a central processing unit, a graphics processing unit, a microprocessor, a controller, a microcontroller, a digital signal processor, a field-programmable gate array, an application-specific integrated circuit, and/or another type of processing component. The processor 320 may be implemented in hardware, firmware, or a combination of hardware and software. In some implementations, the processor 320 may include one or more processors capable of being programmed to perform one or more operations or processes described elsewhere herein.

The memory 330 may include volatile and/or nonvolatile memory. For example, the memory 330 may include random access memory (RAM), read only memory (ROM), a hard disk drive, and/or another type of memory (e.g., a flash memory, a magnetic memory, and/or an optical memory). The memory 330 may include internal memory (e.g., RAM, ROM, or a hard disk drive) and/or removable memory (e.g., removable via a universal serial bus connection). The memory 330 may be a non-transitory computer-readable medium. The memory 330 may store information, one or more instructions, and/or software (e.g., one or more software applications) related to the operation of the device 300. In some implementations, the memory 330 may include one or more memories that are coupled (e.g., communicatively coupled) to one or more processors (e.g., processor 320), such as via the bus 310. Communicative coupling between a processor 320 and a memory 330 may enable the processor 320 to read and/or process information stored in the memory 330 and/or to store information in the memory 330.

The input component 340 may enable the device 300 to receive input, such as user input and/or sensed input. For example, the input component 340 may include a touch screen, a keyboard, a keypad, a mouse, a button, a microphone, a switch, a sensor, a global positioning system sensor, a global navigation satellite system sensor, an accelerometer, a gyroscope, and/or an actuator. The output component 350 may enable the device 300 to provide output, such as via a display, a speaker, and/or a light-emitting diode. The communication component 360 may enable the device 300 to communicate with other devices via a wired connection and/or a wireless connection. For example, the communication component 360 may include a receiver, a transmitter, a transceiver, a modem, a network interface card, and/or an antenna.

The device 300 may perform one or more operations or processes described herein. For example, a non-transitory computer-readable medium (e.g., memory 330) may store a set of instructions (e.g., one or more instructions or code) for execution by the processor 320. The processor 320 may execute the set of instructions to perform one or more operations or processes described herein. In some implementations, execution of the set of instructions, by one or more processors 320, causes the one or more processors 320 and/or the device 300 to perform one or more operations or processes described herein. In some implementations, hardwired circuitry may be used instead of or in combination with the instructions to perform one or more operations or processes described herein. Additionally, or alternatively, the processor 320 may be configured to perform one or more operations or processes described herein. Thus, implementations described herein are not limited to any specific combination of hardware circuitry and software.

The number and arrangement of components shown in FIG. 3 are provided as an example. The device 300 may include additional components, fewer components, different components, or differently arranged components than those shown in FIG. 3. Additionally, or alternatively, a set of components (e.g., one or more components) of the device 300 may perform one or more functions described as being performed by another set of components of the device 300.

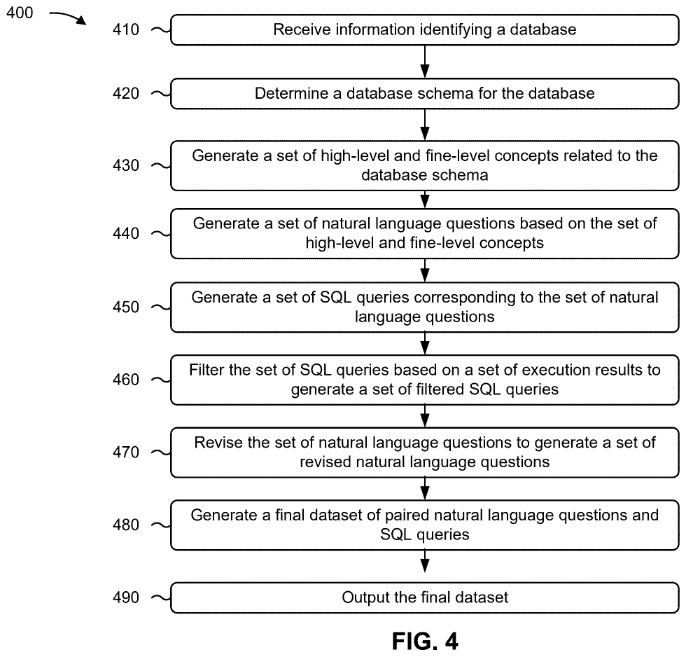

FIG. 4 is a flowchart of an example process 400 associated with database querying using natural language processing. In some implementations, one or more process blocks of FIG. 4 are performed by a computer system (e.g., query generation system 202). In some implementations, one or more process blocks of FIG. 4 are performed by another device or a group of devices separate from or including the computer system. Additionally, or alternatively, one or more process blocks of FIG. 4 may be performed by one or more components of device 300, such as processor 320, memory 330, input component 340, output component 350, and/or communication component 360.

As shown in FIG. 4, process 400 may include receiving information identifying a database (block 410). For example, the computer system may receive information identifying a database, as described above.

As further shown in FIG. 4, process 400 may include determining a database schema for the database (block 420). For example, the computer system may determine a database schema for the database, as described above.

As further shown in FIG. 4, process 400 may include generating a set of high-level concepts and fine-level related to the database schema (block 430). For example, the computer system may generate a set of high-level concepts related to the database schema and a set of fine-level concepts related to each high-level concept, as described above.

As further shown in FIG. 4, process 400 may include generating a set of natural language questions based on the set of high-level and fine-level concepts (block 440). For example, the computer system may generate a set of natural language questions based on the set of high-level concepts, as described above.

As further shown in FIG. 4, process 400 may include generating a set of SQL queries corresponding to the set of natural language questions (block 450). For example, the computer system may generate a set of SQL queries corresponding to the set of natural language questions, as described above.

As further shown in FIG. 4, process 400 may include filtering the set of SQL queries based on a set of execution results to generate a set of filtered SQL queries (block 460). For example, the computer system may filter the set of SQL queries based on a set of execution results to generate a set of filtered SQL queries, as described above.

As further shown in FIG. 4, process 400 may include revising, based on filtering the set of SQL queries, the set of natural language questions to generate a set of revised natural language questions (block 470). For example, the computer system may revise, based on filtering the set of SQL queries, the set of natural language questions to generate a set of revised natural language questions, as described above.

As further shown in FIG. 4, process 400 may include generating a final dataset of paired natural language questions and SQL queries (block 480). For example, the computer system may filter the set of revised natural language questions and the set of filtered SQL queries based on schema linking to generate a final dataset of paired natural language questions and SQL queries, as described above.

As further shown in FIG. 4, process 400 may include outputting the final dataset of paired natural language questions and SQL queries (block 490). For example, the computer system may output the final dataset of paired natural language questions and SQL queries, as described above.

Process 400 may include additional implementations, such as any single implementation or any combination of implementations described below and/or in connection with one or more other processes described elsewhere herein.

In a first implementation, the operations further comprise fine-tuning a text-to-SQL model using the final dataset of paired natural language questions and SQL queries.

In a second implementation, alone or in combination with the first implementation, the set of high-level concepts is generated using a custom prompt structure to query a language model.

In a third implementation, alone or in combination with one or more of the first and second implementations, the set of natural language questions is generated using a custom prompt structure to query a language model, the prompt structure including the set of high-level concepts and the database schema.

In a fourth implementation, alone or in combination with one or more of the first through third implementations, the set of SQL queries is generated using a text-to-SQL system, and the set of execution results is used to filter out one or more SQL queries that are not executable or that return empty results.

In a fifth implementation, alone or in combination with one or more of the first through fourth implementations, the set of revised natural language questions is generated using a custom prompt structure to query a language model, the prompt structure including the SQL queries and schema representation.

In a sixth implementation, alone or in combination with one or more of the first through fifth implementations, the schema linking is used to filter out one or more paired natural language questions and SQL queries that are associated with a correspondence score that is less than a threshold value.

In a seventh implementation, alone or in combination with one or more of the first through sixth implementations, the final dataset of paired natural language questions and SQL queries is output in a JSON file format.

Although FIG. 4 shows example blocks of process 400, in some implementations, process 400 includes additional blocks, fewer blocks, different blocks, or differently arranged blocks than those depicted in FIG. 4. Additionally, or alternatively, two or more of the blocks of process 400 may be performed in parallel.

The following provides an overview of some Aspects of the present disclosure:

In some implementations, a computer-implemented method, comprises: receiving, by a processor set, a database schema identifying a set of characteristics of a target database; determining, by the processor set and based on the database schema, a group of database concept sets for the target database, wherein each database concept set, of the group of database concept sets, includes a primary concept and a set of secondary concepts relating to the primary concept; generating, by the processor set, a group of first query parts relating to the group of database concept sets; generating, by the processor set, a group of second query parts corresponding to the group of first query parts, wherein the group of first query parts includes one or more natural language query parts and wherein the group of second query parts includes one or more corresponding query language query parts; and outputting, by the processor set, a dataset identifying the group of first query parts and the group of second query parts corresponding to the group of first query parts.

In some implementations, the target database is a relational database.

In some implementations, the computer-implemented method comprises: receiving information identifying a glossary of concepts; and wherein determining the group of database concept sets comprises: determining the group of database concept sets based on the glossary of concepts.

In some implementations, determining the group of database concept sets comprises: de-duplicating an initial set of database concept sets to generate a final set of database concept sets as the group of database concept sets.

In some implementations, determining the group of database concept sets comprises: applying the database schema to the primary concept to generate the set of secondary concepts for the primary concept.

In some implementations, generating the group of first query parts comprises: identifying a set of candidate query parts stored at a data source; and selecting the group of first query parts from the set of candidate query parts.

In some implementations, generating the group of second query parts comprises: executing a natural-language-to-query-language model to convert the group of first query parts into the group of second query parts.

In some implementations, generating the group of second query parts comprises: test-executing a candidate query part; determining whether a result of test-executing the candidate query part satisfies an execution criterion; and selectively including the candidate query part in the group of second query parts based on whether the result of test-executing the candidate query part satisfies the execution criterion.

In some implementations, the computer-implemented method comprises: filtering the group of second query parts based on a set of execution results.

In some implementations, the computer-implemented method comprises: revising the group of first query parts based on the group of second query parts.

In some implementations, generating the group of database concept sets comprises: generating the group of database concept sets using a nested generation technique.

In some implementations, a computer system, comprises a processor set; one or more computer-readable storage media; and program instructions stored on the one or more computer-readable storage media to cause the processor set to perform operations comprising: receiving information identifying a database; determining a database schema for the database; generating a set of high-level concepts related to the database schema; generating a set of natural language questions based on the set of high-level concepts; generating a set of structured query language (SQL) queries corresponding to the set of natural language questions; filtering the set of SQL queries based on a set of execution results to generate a set of filtered SQL queries; revising, based on filtering the set of SQL queries, the set of natural language questions to generate a set of revised natural language questions; filtering the set of revised natural language questions and the set of filtered SQL queries based on schema linking to generate a final dataset of paired natural language questions and SQL queries; and outputting the final dataset of paired natural language questions and SQL queries.

In some implementations, the operations further comprise: fine-tuning a text-to-SQL model using the final dataset of paired natural language questions and SQL queries.

In some implementations, the set of high-level concepts is generated using a custom prompt structure to query a language model.

In some implementations, the set of natural language questions is generated using a custom prompt structure to query a language model, the prompt structure including the set of high-level concepts and the database schema.

In some implementations, the set of SQL queries is generated using a text-to-SQL system, and the set of execution results is used to filter out one or more SQL queries that are not executable or that return empty results.

In some implementations, the set of revised natural language questions is generated using a custom prompt structure to query a language model, the prompt structure including the SQL queries and schema representation.

In some implementations, the schema linking is used to filter out one or more paired natural language questions and SQL queries that are associated with a correspondence score that is less than a threshold value.

In some implementations, the final dataset of paired natural language questions and SQL queries is output in a Javascript Object Notation (JSON) file format.

In some implementations, a computer program product comprises: a processor set; one or more computer-readable storage media; and program instructions stored on the one or more computer-readable storage media to cause the processor set to perform operations comprising: receiving a database schema identifying a set of characteristics of a target database; determining, based on the database schema, a group of database concepts for the target database; generating a set of natural language statements relating to the group of database concept sets; generating a set of structured language statements corresponding to the set of natural language statements; executing the set of structured language statements; filtering the set of structured language statements based on a set of results of executing the set of structured language statements; updating the set of natural language statements based on filtering the set of structured language statements; and outputting a dataset identifying a result of updating the set of natural language statements and filtering the set of structured language statements.

In some implementations, a system is configured to perform one or more operations recited herein.

In some implementations, an apparatus comprises means for performing one or more operations recited herein.

In some implementations, a non-transitory computer-readable medium stores a set of instructions, the set of instructions comprising one or more instructions that, when executed by a device, cause the device to perform one or more operations recited herein.

In some implementations, a computer program product comprises instructions or code for executing one or more operations recited in one or more of Aspects 1-20.

As an example, a technical effect of one or more implementations described herein is to improve an accuracy of database querying. Additionally, or alternatively, a technical effect of one or more implementations described herein is to improve an accuracy of text-to-SQL models. Additionally, or alternatively, a technical effect of one or more implementations described herein is to reduce an amount of time associated with retrieving information from a database. Additionally, or alternatively, a technical effect of one or more implementations described herein is to reduce a likelihood of redundant database queries being performed, thereby reducing processor utilization, data storage, or network resource utilization, among other examples.

The foregoing disclosure provides illustration and description, but is not intended to be exhaustive or to limit the implementations to the precise forms disclosed. Modifications may be made in light of the above disclosure or may be acquired from practice of the implementations. For example, various aspects of this disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

A computer program product embodiment (“CPP embodiment” or “CPP”) is a term used in this disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer-readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, RAM, ROM, erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc), or any suitable combination of the foregoing. A computer-readable storage medium, as that term is used in this disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the implementations. Thus, the operation and behavior of the systems and/or methods are described herein without reference to specific software code-it being understood that software and hardware can be used to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

Although particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiple of the same item.

When “a processor” or “one or more processors” (or another device or component, such as “a controller” or “one or more controllers”) is described or claimed (within a single claim or across multiple claims) as performing multiple operations or being configured to perform multiple operations, this language is intended to broadly cover a variety of processor architectures and environments. For example, unless explicitly claimed otherwise (e.g., via the use of “first processor” and “second processor” or other language that differentiates processors in the claims), this language is intended to cover a single processor performing or being configured to perform all of the operations, a group of processors collectively performing or being configured to perform all of the operations, a first processor performing or being configured to perform a first operation and a second processor performing or being configured to perform a second operation, or any combination of processors performing or being configured to perform the operations. For example, when a claim has the form “one or more processors configured to: perform X; perform Y; and perform Z,” that claim should be interpreted to mean “one or more processors configured to perform X; one or more (possibly different) processors configured to perform Y; and one or more (also possibly different) processors configured to perform Z.”

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

1. A computer-implemented method, comprising:
receiving, by a processor set, a database schema identifying a set of characteristics of a target database;
determining, by the processor set and based on the database schema, a group of database concept sets for the target database,
wherein each database concept set, of the group of database concept sets, includes a primary concept and a set of secondary concepts relating to the primary concept;
generating, by the processor set, a group of first query parts relating to the group of database concept sets;
generating, by the processor set, a group of second query parts corresponding to the group of first query parts,
wherein the group of first query parts includes one or more natural language query parts and wherein the group of second query parts includes one or more corresponding query language query parts; and
outputting, by the processor set, a dataset identifying the group of first query parts and the group of second query parts corresponding to the group of first query parts.

2. The computer-implemented method of claim 1, wherein the target database is a relational database.

3. The computer-implemented method of claim 1, further comprising:
receiving information identifying a glossary of concepts; and
wherein determining the group of database concept sets comprises:
determining the group of database concept sets based on the glossary of concepts.

4. The computer-implemented method of claim 1, wherein determining the group of database concept sets comprises:
de-duplicating an initial set of database concept sets to generate a final set of database concept sets as the group of database concept sets.

5. The computer-implemented method of claim 1, wherein determining the group of database concept sets comprises:
applying the database schema to the primary concept to generate the set of secondary concepts for the primary concept.

6. The computer-implemented method of claim 1, wherein generating the group of first query parts comprises:
identifying a set of candidate query parts stored at a data source; and
selecting the group of first query parts from the set of candidate query parts.

7. The computer-implemented method of claim 1, wherein generating the group of second query parts comprises:
executing a natural-language-to-query-language model to convert the group of first query parts into the group of second query parts.

8. The computer-implemented method of claim 1, wherein generating the group of second query parts comprises:
test-executing a candidate query part;
determining whether a result of test-executing the candidate query part satisfies an execution criterion; and
selectively including the candidate query part in the group of second query parts based on whether the result of test-executing the candidate query part satisfies the execution criterion.

9. The computer-implemented method of claim 1, further comprising:
filtering the group of second query parts based on a set of execution results.

10. The computer-implemented method of claim 1, further comprising:
revising the group of first query parts based on the group of second query parts.

11. The computer-implemented method of claim 1, wherein generating the group of database concept sets comprises:
generating the group of database concept sets using a nested generation technique.

12-19. (canceled)

20. A computer program product, comprising:
a processor set;
one or more computer-readable storage media; and
program instructions stored on the one or more computer-readable storage media to cause the processor set to perform operations comprising:
receiving a database schema identifying a set of characteristics of a target database;
determining, based on the database schema, a group of database concepts for the target database;
generating a set of natural language statements relating to the group of database concepts;
generating a set of structured language statements corresponding to the set of natural language statements;
executing the set of structured language statements;
filtering the set of structured language statements based on a set of results of executing the set of structured language statements;
updating the set of natural language statements based on filtering the set of structured language statements; and
outputting a dataset identifying a result of updating the set of natural language statements and filtering the set of structured language statements.

21. A system, comprising:
one or more memories; and
one or more processors, coupled to the one or more memories, configured to:
receive a database schema identifying a set of characteristics of a target database;
determine, based on the database schema, a group of database concept sets for the target database,
wherein each database concept set, of the group of database concept sets, includes a primary concept and a set of secondary concepts relating to the primary concept;
generate a group of first query parts relating to the group of database concept sets;
generate a group of second query parts corresponding to the group of first query parts,
wherein the group of first query parts includes one or more natural language query parts and wherein the group of second query parts includes one or more corresponding query language query parts; and
output a dataset identifying the group of first query parts and the group of second query parts corresponding to the group of first query parts.

22. The system of claim 21, wherein the target database is a relational database.

23. The system of claim 21, wherein the one or more processors are further configured to:
receive information identifying a glossary of concepts; and
wherein the one or more processors, to determine the group of database concept sets, are configured to:
determine the group of database concept sets based on the glossary of concepts.

24. The system of claim 21, wherein the one or more processors, to determine the group of database concept sets, are configured to:
de-duplicate an initial set of database concept sets to generate a final set of database concept sets as the group of database concept sets.

25. The system of claim 21, wherein the one or more processors, to determine the group of database concept sets, are configured to:
apply the database schema to the primary concept to generate the set of secondary concepts for the primary concept.

26. The system of claim 21, wherein the one or more processors, to generate the group of first query parts, are configured to:
identify a set of candidate query parts stored at a data source; and
select the group of first query parts from the set of candidate query parts.

27. The system of claim 21, wherein the one or more processors, to generate the group of second query parts, are configured to:
execute a natural-language-to-query-language model to convert the group of first query parts into the group of second query parts.

28. The system of claim 21, wherein the one or more processors, to generate the group of second query parts, are configured to:
test-execute a candidate query part;
determine whether a result of test-executing the candidate query part satisfies an execution criterion; and
selectively include the candidate query part in the group of second query parts based on whether the result of test-executing the candidate query part satisfies the execution criterion.
